(19) United States
(12) Patent Application Publication
(10) Pub. No.: US 2009/0183148 A1
(43) Pub. Date: Jul. 16, 2009

(54) REMOTE INSTALLATION

(76) Inventor: Nitin BAGRECHA, Erlangen (DE)

Correspondence Address: BRINKS HOFER GILSON & LIONE, P.O. BOX 10395, CHICAGO, IL, 60610, US

(21) Appl. No.: 12/013,702

(22) Filed: Jan. 14, 2008

(51) Int. Cl. G06F 9/44

(52) U.S. Cl. 717/171

(57) ABSTRACT

A remote delivery system for delivering software is provided. The system includes a software receiving system; and a software delivery system operable to automatically deliver software to the receiving system. The software delivery system is operable to determine a delivery time, the delivery time being a function of timing information stored in the software delivery system. The software delivery system is operable to deliver the software at the delivery time,

### BACKGROUND

The present embodiments relate to remote installation. A remote installation system may include a delivery system and a receiving system with a client workstation. The client workstation processes software to operate hardware. The software may be installed or upgraded from a remote location. The delivery system may deliver the software from the remote location. The operator of the delivery system must determine or remember when the client workstation needs software installed or upgraded. The operator manually triggers the software delivery. A data management system may remind the operator to deliver the software to the client workstation. Even with the reminder, the operator may forget to deliver the software to the remote client workstation.

Manual delivery may include the operator accessing the delivery system and specifying the location and time of delivery. The operator is also required to specify or upload the software to be delivered. The operator may accidentally specify the wrong software or client workstation.

Even if the software is manually delivered to the correct client workstation, the operator may fail to update the data management system when the software has been delivered or installed.

### SUMMARY

The present embodiments relate to automatic installation of software. A software delivery system may determine when the software receiving system is available for installation and deliver the software at the available time.

In a first aspect, a remote delivery system delivers software. The system includes a software receiving system and a software delivery system. The software delivery system can automatically deliver software to the receiving system. The software delivery system can determine a delivery time. The delivery time being defined by timing information stored in the software delivery system. The software delivery system can deliver the software at the delivery time.

In a second aspect, a remote installation system installs software. The system includes a data management system and a software receiving system. The data management system can determine a time that the software receiving system is available for installation. The software is installed at the determined time.

In a third aspect, a remote installation system can install software for an imaging device. The system includes an imaging device and a software delivery system. The software delivery system can deliver software to the imaging device, The software delivery system determines when the imaging device is not imaging and delivers the software at this time.

In a fourth aspect, a method for remote installation of software includes determining an available time to deliver software to the software receiving system with a data management system, the available time being a time that the software receiving system is operable to install software; and delivering the software to the software receiving system at the determined available time with the data management system.

In a fifth aspect, computer readable storage media has stored therein data representing instructions executable for delivering software to a software receiving system. The instructions include identifying a scheduled downtime for the software receiving system, the schedule downtime being stored in and identified by a software delivery system; and delivering the software at the scheduled downtime.

### BRIEF DESCRIPTION OF THE FIGURES

FIG. 1 is a block diagram of one embodiment of a remote installation system.

FIG. 2 is a block diagram of one embodiment of a software delivery system.

FIG. 3 is a block diagram of one embodiment of a software receiving system.

FIG. 4 is a flow chart diagram of one embodiment of a method for remote installation.

### DETAILED DESCRIPTION

The present embodiments relate to remote installation of software. A customer may fill out a scheduled downtime form. The information on the form may be stored in a “systems, applications, and processing” (SAP) system. The SAP system triggers the automated upgrade/installation of the application depending upon the downtime specified by the customer Upon completion of installation, the SAP system is automatically updated with the information about the upgrade or installation. Other techniques may be used to determine the downtime.

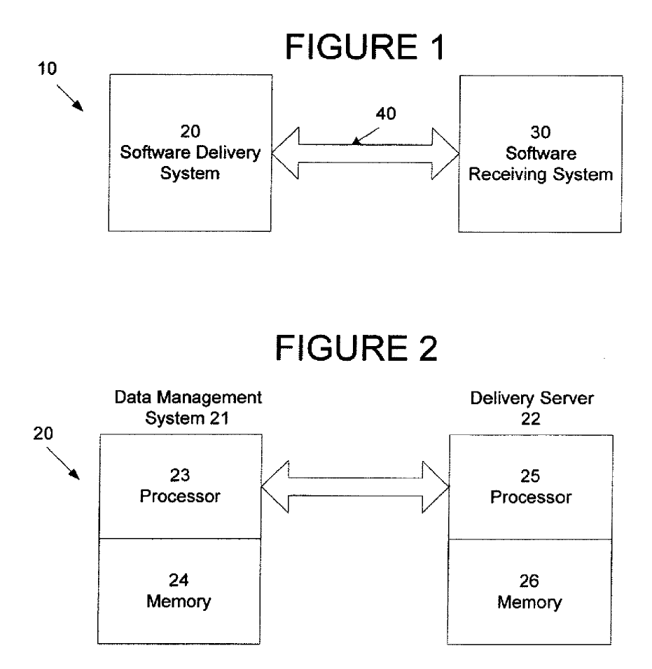

FIG. 1 shows a remote installation system 10 for installing software. The remote installation system 10 includes a software delivery system 20, a software receiving system 30, and a network 40 providing communication between the delivery system 20 and the receiving system 30. Additional, different, or fewer components may be provided. The remote installation system 10 is a network communication system or other now known or later developed system for the automatic delivery of software from one system to another system. The installation system 10 automatically installs software on the software receiving system 30. For example, the installation system 10 may automatically install software for use or service by the software receiving system 30. The automatic installation may be in accordance with a software order schedule stored in the software delivery system 20. For example, the software may be automatically installed or delivered at a software receiving system downtime. The downtime being automatically determined by the software delivery system 20. In another example, the software may be automatically installed at an installation availability time of the software receiving system 30.

The network 40 may include a dedicated communication line, wireless device, the combination thereof, or any now known or later developed communication device. The network 40 is a computer network, such as the Internet, an intranet, a local area network, a wide area network, or other communications network. Additional, different, or fewer communication devices may be provided. The network 40 may communicatively connect the software delivery system 20 to the software receiving system 30. The connection may be secure. For example, the network 40 may be a secured pipe, PN-line, VPN-line, encryption line, secured Internet connection, or other now known or later developed secure connection. The network 40 transmits commnunication signals, software, confirmation signals, messages, text data, image data, or other information. For example, the network 40 may transmit software, scheduled downtime information, installation availability information, a software delivery signal, a confirmation signal, or any combination thereof from one to the other or back and forth between the software delivery system 20 and the software receiving system 30.

FIG. 2 shows one embodiment of a software delivery system 20. The software delivery system 20 may include a data management system 21 and a server 22. Additional, different, or fewer components may be provided. For example, in an alternative embodiment, the software delivery system 20 may include a single processor and memory that perform the functions of both the data management system 21 and the server 22. In another example, the software delivery system 20 may include a plurality of servers 22.

The software delivery system 20 is a personal computer, workstation, network, server, processing system, or other now known or later developed system for delivery of software. The software delivery system 20 operates to automatically deliver software to the software receiving system 30 at a delivery time. For example, the software delivery system 20 is a computer aided delivery system for delivery of software. Automated assistance is provided for automatic or semiautomatic delivery of software. Delivery occurs in accordance with timing information stored in the software delivery system 20, such as scheduled downtime for the software receiving system 30 or installation availability of the software receiving system 30. The software delivery system 20 automatically provides software to the software receiving system 30 based on information relating the software receiving system 30, such as the currently installed software version, last update time, or other information relating to the receiving system 30.

The data management system 21 may include a processor 23 and a memory 24. Additional, different, or fewer components may be provided. For example, the data management system 21 may include a relational database, display device, or input device.

The data management system 21 is an enterprise resource planning (ERP) system, SAP system, personal computer, server, workstation, docket system, business management system, network, medical management system, banking system, pharmaceutical system, or other now known or later developed system for managing business. For example, the data management system 21 system is a computer aided system for managing software delivery, software delivery orders, product planning, parts purchasing, maintaining inventories, interacting with suppliers, providing customer service, tracking orders, or any combination thereof In another example, the data management system 25 includes application modules for the finance and human resource aspects of a business. The data management system 21 may use or be integrated with a relational database system. The data management system 21 can be used for business process analysis, employee retraining, and new work procedures.

The data management system 21 may integrate all data and processes of software delivery into a unified system. The data management system may use multiple components of computer software and hardware to achieve integration. The data management system 21 may use a unified database to store data for the various stages or components of software delivery. For example, the software receiving system 30 may include medical hardware, such as a computer tomography (CT) system, a magnetic resonance imaging (MRI) system, or other medical device. The data management system 21 may receive a signal from the receiving system 30. The signal may include information on a scheduled downtime form filled out by a client. The signal may define a delivery time, such as a scheduled downtime for the medical hardware. Alternatively, the signal may identify an installation availability time. The data management system 21 may communicate with a clock to compare the current time to the defined downtime to determine the delivery time. In another example, the data management system 21 may also communicate with a software database to determine the type of software currently installed on the medical device. The data management system 21 may compare the type of software currently installed on the specific device to a list of currently available software to determine the most current uninstalled software available for the medical device.

As shown in FIG. 2, the data management system 21 may include a processor 23. The processor 23 is a general processor, digital signal processor, application specific integrated circuit, field programmable gate array, analog circuit, digital circuit, combinations thereof, or other now known or later developed processor. The processor 23 may be a single device or a combination of devices, such as associated with a network or distributed processing. Any of various processing strategies may be used, such as multi-processing, multi-tasking, parallel processing, or the like. The processor 23 is responsive to instructions stored as part of software, hardware, integrated circuits, firmware, micro-code or the like.

The processor 23 communicates with the memory 24 and the delivery server 22. The processor 23 may communicate with additional, different, or fewer components. The processor 23 may use a dedicated communication line, communication circuit, or wireless device to send or receive communication data. For example, the processor 23 may communicate with the server 22 using a secured communication line. In another example, the processor 23 retrieves or stores software, application instruction, or other information or data in the memory 24 using a communication circuit. In another example, the processor 23 may communicate with a relational database using a communication circuit.

The processor 23 may analyze information relating to the software receiving system 30. The information may be stored in the memory 24, received from the server 22, received from the software receiving system 30, or provided from an input device. The information may include software, software-related information, instructions, order information, confirmation information, address information, time of delivery information, hardware information, database information, business model data, software order instructions, software order information, medical information, banking information, pharmaceutical information, or other information relating to a software receiving system 30, software delivery system 20, or installation system 10.

Analysis of the information relating to the software receiving system 30 may include determining a delivery time, a type of software to be delivered, a delivery address, delivery information, a delivery reminder, an event, a due date, a confirmation, other software order related information, or any combination thereof. For example, the processor 23 may determine when a medical device has scheduled downtime. Scheduled downtime may include a time period when the medical device is available to install software. In another example, the processor 23 may determine when software receiving system 30 is available for installation of software. In another example, the processor 23 may when software was last delivered to the software receiving system 30. In another example, the processor 23 may determine the delivery address, the software to be delivered to the address, and the time of delivery of the software.

The processor 23 may organize and manage the information relating to the software receiving system 30 in a relational database, such as a software installation schedule. The relational database may be used to determine one or more software order events, such as a delivery time. For example, the relational database may be updated to include information relating to newly developed software for a CT device. The relational database may include a list of the software receiving systems 30 that include the CT device. The processor 23 may analyze the list of CT devices and the information relating to newly developed software. Analysis may include determining when the CT devices are available for installation.

The processor 23 may generate a software delivery signal based on the analysis of the information relating to the software receiving system 30. For example, as discussed in the paragraph above, the processor 23 may generate a software delivery signal for the software receiving systems 30 for which newly developed software exists. In another example, the processor 23 may generate a software delivery signal when the software receiving system 30 needs software.

The software delivery signal may include an instruction to delivery software at a delivery time. Additional, fewer, or different instructions may be included. For example, the software delivery signal may include an instruction to deliver the software to a specific address. In another example, the software delivery signal includes a reminder signal.

The processor 23 may communicate the software delivery signal to the server 22. The processor 23 may communicate the software delivery signal to additional, fewer, or different components. For example, the processor 23 may communicate the software delivery signal, which may include the software to be installed, directly to the software receiving system 30.

The processor 23 may communicate the software delivery signal at a defined time. The defined time may include the time at which the software is to be delivered. For example, the medical hardware, such as a CT device, may be unable to receive software during an uptime because the CT device is functioning. As another example, the CT device may not operate with desired speed if both functioning to image and receiving software. The software may be installed during a downtime, such as in the evening when the medical hardware is not functioning. The scheduled downtime may be stored in a relational database. The processor 23 may communicate the software delivery signal to the software delivery server 22 during the scheduled downtime. In another example, the processor 23 may communicate the software delivery signal to the software delivery server 22 during an uptime but include an instruction to not deliver the software until a downtime. In another example, the software delivery signal may be communicated at any time.

As shown in FIG. 2, the data management system 21 may include a memory 24. The memory 24 is a computer readable storage media. Computer readable storage media includes various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 24 may be a single device or a combination of devices. The memory 24 may be adjacent to, part of, networked with and/or remote from the processor 23.

The memory 24 may store information. The information may include, but is not limited to, software, scheduled downtime information, installation availability information, installed software information, instructions, order information, confirmation information, address information, time of delivery information, hardware information, database information, business model data, software order instructions, software order information, medical information, banking information, pharmaceutical information, image data, patient information, or other information relating to a software receiving system, software delivery system, or installation system. The information may be stored in the memory 24 by the processor 21 or other input device, such as a CD-ROM, keyboard, computer mouse, remote processor, or remote server.

Software may include a computer program, a collection of computer programs, a software upgrade, a software update, a sequence of instructions, application software, system software, middleware, and related documentation. For example, the software may be used by a processor to engage and operate the medical hardware, such as a CT device, in the software receiving system 30. In another example, software may include platform software, such as firmware, device drivers, an operating system, and graphical user interface. In another example, software may include software upgrades or updates. The software upgrades or updates may include changes or additions to all or a portion of the software currently installed on a system.

Software information may include information about the software to be delivered to software receiving system 30. The software information may define the software to be delivered to the software receiving system 30. For example, the software may be stored in the memory 24. The software information may be used to identify and locate the desired software in the memory 24. In another example, the medical device may include a CT device that needs a software update for a specific CT function. The software information may define the update.

Installed software information may include information about the software currently installed on the software receiving system 30. The installed software information may be used to determine if software should be sent to the software receiving system 30. For example, the installed software information may define the current version installed on the software receiving system 30. The installed software information may be used to determine if the software is outdated. In another example, the software information may be used to determine that software has not been installed on the software receiving system 30. In another example, the software information may be used to determine the number or version of software grades installed on the software receiving system 30. In another example, the installed software information may also include information about software that was delivered to the software receiving system 30, even if it was not installed.

Order information may include information about past, present, or future software orders. For example, order information may include software delivery information, such as the date of the last software delivery to a specific device. In another example, order information may include scheduled delivery information, such as information about a time for software to be delivered. The order information may indicate the types of software or software packages to be available to a particular device.

Confirmation information may include information confirming that software was installed. For example, confirmation information may confirm that the correct software was installed on a defined device in the software receiving system 30. In another example, the confirmation information may include information confirming that the software was delivered to the software receiving system 30. In another example, the confirmation information may include information confirming that the software was not installed.

Address information may include information defining a delivery location. For example, address information may include a CT device address. The address information may include an internet protocol address, a network address, a workstation address, server address, or other now known or later developed address.

Time of delivery information may include information relating to a delivery time. The delivery time may be defined by a receiving time. The receiving time may be downtime of the receiving system 30, workstation 32 or other device in the workstation 32. Downtime may be a time that the receiving system 30, workstation 32 or medical device in the workstation 32 is not functioning. The receiving time may be an installation availability time of the receiving system 30, workstation 32 or other device in the workstation 32. Installation availability time may be a time that the receiving system 30 is available to receiver or install software.

Hardware information may include information relating to the hardware in the software receiving system 30. For example, hardware information may relate to a medical device, such as a treatment or diagnosis device. An imaging device may be a medical device. Imaging devices may include a CT device or MRI device. In another example, hardware information may relate to a banking device or accounting device.

The memory 24 may store a relational database. The relational database may relate or integrate information together. For example, the hardware information may relate to delivery time information. In another example, software information may relate to hardware information.

The memory 24 may store ERP software. The ERP software may be processed by the processor 23. The ERP software provides computer-assisted order tracking from acceptance through fulfillment to determine software schedules, such as a scheduled downtime. For example, the memory 24 stores multi-module application instructions. The instructions may be used to manage one or more applications. In another example, the memory 24 may also store SAP software.

FIG. 2 shows the server 22 including a processor 25 and a memory 26. Additional, different, or fewer components may be provided. For example, the server 22 may include a console, display device, or input device. The server 22 is a network server, a remote server, a central server, a terminal server, a delivery server, a receiving server, or any other now known or later developed server that delivers software. The server 22 communicates with the software receiving system 30 using the network 40. For example, the server 22 delivers software, information, signals, or any combination thereof to the software receiving system 30. In another example, the server 22 receives software, information, or signals from the software receiving system 30.

The processor 25 is a general processor, digital signal processor, application specific integrated circuit, field programmable gate array, analog circuit, digital circuit, combinations thereof, or other now known or later developed processor. The processor 25 may be a single device or a combination of devices, such as associated with a network or distributed processing. Any of various processing strategies may be used, such as multi-processing, multi-tasking, parallel processing, or the like. The processor 25 is responsive to instructions stored as part of software, hardware, integrated circuits, firmware, micro-code or the like.

The processor 25 may communicate with the memory 26 and/or one or more software receiving systems 30. The processor 25 may communicate with additional, different, or fewer components. For example, the processor 25 may communicate with the processor 23 of the data management system 21.

The processor 25 may send or receive communication using a dedicated communication line, communication circuit, or wireless device. For example, the processor 25 may use a communication circuit to retrieve software stored in the memory 26. In another example, the processor 25 may communicate with the software receiving system 30 using the network 40, which may be a secured communication line, secured pipe, PN-line, or VPN-line. In another example, the processor 25 may communicate with a relational database using a communication circuit. In another example, the processor 25 may transmit encrypted communication data to the software receiving system 30.

The processor 25 may retrieve or store software in the memory 24. The processor 25 may retrieve or store other information in the memory 24. For example, the processor 25 may retrieve server application instructions from the memory 26 to engage and operate the server 22. In another example, the processor 25 may retrieve software from the memory 26 in accordance with the software delivery signal. The software may be the software to be delivered to the software receiving system 30.

The processor 25 may receive the software delivery signal from the data management system 25. Upon receipt, the processor 25 may analyze the software delivery signal, store the signal in the memory 26 for later analysis, or the combination thereof.

The processor 25 may analyze the software delivery signal. The processor 25 may analyze the software delivery signal to determine a scheduled downtime for the software receiving system, an installation availability time, the software to be delivered, a software receiving system address, client workstation 31 address, the type of software to be delivered, time of delivery, or other information relating to the delivery of software to the software receiving system 30. The processor 25 may analyze all or a portion of the software delivery signal.

The processor 25 may retrieve software stored in memory 26. The processor 25 may retrieve software defined by the software delivery signal. For example, the software delivery signal may include an instruction to delivery CT software to a CT device processor in the software receiving system 30. The processor 25 may analyze the instruction and retrieve the CT software stored in the memory 26. In another example, the processor 25 may retrieve the software from another component, such as a CD-ROM, network, remote processor, or remote server.

The processor 25 may deliver software to the software receiving system 30. The processor 25 may deliver software at the delivery time. For example, the processor 25 may deliver software at a downtime or installation availability time. The processor 25 may deliver the software to an address defined by the software delivery signal. For example, the processor 25 may deliver CT software to a CT device in the software receiving system 30. The processor 25 may encrypt or secure the software for delivery. The processor 25 may deliver the software on or to additional, different, or fewer components.

The processor 25 may cause the software to be installed on one or more devices in the software receiving system 30. For example, the processor 25 may deliver and request installation of the software on the software receiving server 31, workstation 32, or the combination thereof. The processor 25 may cause installation of the software on additional, different, or fewer components.

The memory 26 is a computer readable storage media. Computer readable storage media includes various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 26 may be a single device or a combination of devices. The memory 26 may be adjacent to, part of, networked with and/or remote from the processor 25.

The memory 26 stores information. The information may include, but is not limited to, software, installed software information, scheduled downtime information, installation availability information, instructions, order information, confirmation information, address information, time of delivery information, hardware information, database information, business model data, software order instructions, software order information, medical information, banking information, pharmaceutical information, image data, patient information, or other information relating to a software receiving system, software delivery system, or installation system. The information may be input into the memory 26 using the processor 25 or another input device, such as a CD-ROM, keyboard, computer mouse, console, network, remote processor, or remote server.

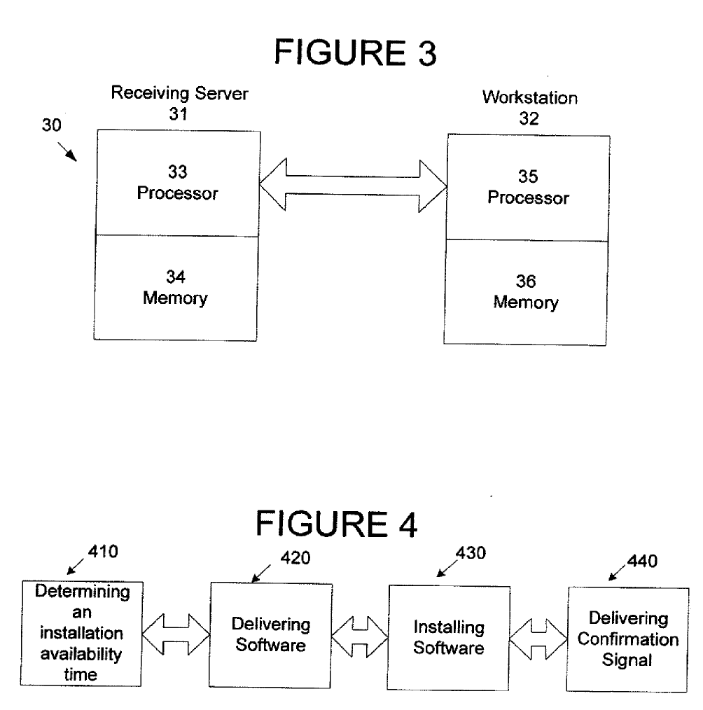

FIG. 3 shows a software receiving system 30 including a software receiving server 31 and client workstation 32. Additional, different, or fewer components may be provided. For example, additional servers 31 may be provided and/or additional client workstations 32 may be provided. In another example, the software receiving system 30 may include one or more medical devices connected to the client workstations 32. The medical devices may include treatment or diagnosis devices. For example, the medical devices may include imaging devices, such as CT devices, MRI devices, C-arm devices. Other medical devices may be provided, such as radiation devices or other medically related devices. In one embodiment, the receiving system 30 includes the medical device without further servers or separate workstations.

The receiving system 30 is a network, an installation system, terminal service system, or other system for installing or running software on one or more servers 31 or client workstations 32. For example, the receiving system 30 is a computer aided installation system for installing software. Automated assistance is provided for automatic installation of the software on a client workstation 32 upon receiving the software from the delivery system 20. Installation being defined by analysis of information relating to the software receiving system 30. In another example, the receiving system 30 is a computer aided installation system for confirming installation of software.

The software receiving server 31 may include a processor 33 and memory 34. Additional, different, or fewer components may be provided. For example, the receiving server 31 may include a display device, input device, and/or console. The software receiving server 31 is a remote server, a central server, application server, a network access server, terminal server, a console server, personal computer, client workstation, or any device that communicates with remote client workstations 32. The receiving server 31 may receive or deliver information. The server 31 works with the client workstations 32 to install software on the workstation 32. Alternatively, the software may be installed on the server 31. For example, the software may be installed on the server 31 for remote use in a terminal service system.

The processor 33 is a general processor, digital signal processor, application specific integrated circuit, field programmable gate array, analog circuit, digital circuit, combinations thereof, or other now known or later developed processor. The processor 33 may be a single device or a combination of devices, such as associated with a network or distributed processing. Any of various processing strategies may be used, such as multi-processing, multi-tasking, parallel processing, or the like. The processor 33 is responsive to instructions stored as part of software, hardware, integrated circuits, firmware, micro-code or the like.

The processor 33 may communicate with the memory 34 and/or the client workstation 32. The processor 33 may communicate with additional, different, or fewer components. For example, the processor 33 may communicate with the processor 25 of the software delivery server 22. In another example, the processor 33 may also communicate directly with the data management system 21. In another example, the processor 33 may communicate with a display device, input device, and/or console.

The processor 33 may use a dedicated communication line, communication circuit, or wireless device to send or receive communication data. For example, the processor 33 may communicate with the software delivery system 20 using a network 40. The network 40 may be secured. For example, the network 40 may be a secured communication line, such as a secured pipe, PN-line, or VPN-line. In another example, the processor 33 may transmit encrypted communication data to the software delivery system 20.

The processor 33 may receive information from the software delivery system 20. The information may include software, scheduled downtime information, installation availability information, delivery information, other information relating to the receiving system 30, or any combination thereof. For example, the processor 33 may receive software for a CT device in a workstation 32 and scheduled downtime information. The scheduled downtime information may define when the workstation 32 is scheduled to not be functioning and available for installation. In another example, the processor 33 receives server software for the server 30. The processor 33 may install the server software on the server 31 for future processing.

The processor 33 may retrieve and/or store software, scheduled downtime, installation availability information, application instructions, information, or other data in the memory 34. For example, the processor 33 may retrieve software stored in the memory 34 for a client workstation 32, such as in a terminal service system. The processor 33 may identify when the client workstation 32 is available to install software, such as when a CT device connected to the workstation 32 is available to install software. At this time, processor 33 may retrieve the CT device software from the memory 34 and deliver the software to the workstation 32.

The processor 33 may use software to engage and operate a device. The device may include a display, wireless device, console, workstation, medical device, banking device, or other device that can communicate with the server 30. For example, the processor 33 may process software for a terminal workstation 32. In another example, the processor 33 may engage and operate a medical device, such as a CT device.

The processor 33 may deliver software to the client workstation 32. Delivery may be at a determined time. The delivery time may be defined by the software delivery signal, information stored in the memory 34, or other information relating to the client workstation 32. For example, the delivery time may be defined by a client workstation 32 downtime or installation availability time. A client workstation 32 downtime may be a time when the client workstation 32 is not functioning. An installation availability time may be a time when the workstation 32 is available to install software.

The processor 33 may deliver software to one or more client workstations 32. For example, the server 31 may be a hospital server that communicates with a plurality of workstations 32 having CT devices. For example, there may be workstation 32 on each floor of the hospital with a CT device. The processor 32 may deliver software to each workstation 32 on each of the floors.

The processor 33 may cause installation of software on a client workstation 32. For example, the processor 33 may store the software on a client workstation memory 36 for future use by a client workstation processor 35. The client workstation processor 35 may process the software to engage and operate a medical device, such as a CT device using the software. The server 31 may cause installation of the software on one or more client workstations 32.

The processor 33 may receive information from the software delivery server 22 or client workstation 32. For example, the processor 33 receives software and/or a software delivery signal from the software delivery server 22. In another example, the processor 33 receives a confirmation signal from the client workstation 32. The confirmation signal may include confirmation data. The confirmation data may include data that confirms proper installation or delivery. Alternatively, the confirmation data may confirm incorrect installation or delivery.

The processor 33 may deliver information to the software delivery server 22 or client workstation 32. For example, the processor 33 may receive the confirmation signal from a client workstation 32 and deliver the confirmation signal to the software delivery system 20. In another example, the processor 33 may transmit scheduled downtime information or installation availability information to the software delivery system 20. Unscheduled downtime may be communicated to the software delivery system 20.

The memory 34 is a computer readable storage media. Computer readable storage media includes various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 34 may be a single device or a combination of devices. The memory 34 may be adjacent to, part of, networked with and/or remote from the processor 33.

The memory 34 stores information. The information may include, but is not limited to, software, scheduled downtime information, installed software information, instructions, order information, confirmation information, address information, time of delivery information, hardware information, database information, business model data, software order instructions, software order information, medical information, banking information, pharmaceutical information, image data, patient information, or other information relating to a software receiving system, software delivery system, or installation system. The information may be input into the memory 34 from the processor 22, software delivery system 20, or another input device, such as a CD-ROM, keyboard, computer mouse, console, network, remote processor, or remote server.

As shown in FIG. 3, the software receiving system 30 may include a workstation 32. Additional, different, or fewer components may be provided. For example, a plurality of workstations 32 may be provided. In another example, the software receiving server 31 and workstation 32 may be a single receiving unit for the installation of software. The single receiving unit may include a processor that performs both the functions of server 31 and the workstation 32.

The workstation 32 may include a processor 35 and a memory 36. Additional, different, or fewer components may be provided. For example, the workstation may include an operational device, display device, input device, or other workstation related device. The operational device may be a medical device, a banking device, a pharmaceutical device, or other now known or later developed device for operation. The operational device may be directly connected to or a part of the workstation 32 or remotely connected to the workstation 32. For example, the operational device may be an imaging device, such as a CT device or MRI device. The workstation 32 may be connected to the imaging device in an examination room. A physician may use an input device, such as a keyboard, connected to the workstation 32 to control the movement and operation of the imaging device.

The workstation 32 is a personal computer, terminal workstation, client terminal, medical processor system, banking processor system, or other now known or later developed processing system. The workstation 32 works with the software receiving server 31 to install software or other information for use by the workstation 32. The workstation 32 may have an address. The address may be a network address, Internet protocol address, or other now known or later developed address used for transmitting information to the workstation 32.

The processor 35 is a general processor, digital signal processor, application specific integrated circuit, field programmable gate array, analog circuit, digital circuit, combinations thereof, or other now known or later developed processor. The processor 35 may be a single device or a combination of devices, such as associated with a network or distributed processing. Any of various processing strategies may be used, such as multi-processing, multi-tasking, parallel processing, or the like. The processor 35 is responsive to instructions stored as part of software, hardware, integrated circuits, firmware, micro-code or the like.

The processor 35 may receive software or other information from the software receiving server 31 or software delivery system 20. The processor 35 may receive information from additional, different, or fewer components. For example, the processor 25 may receive information from an input device, such as a keyboard, CD-ROM, remote server or processor, or other device for inputting information.

The processor 35 may install software for use by the workstation 32. The processor 35 may store the software on the memory 36. The software may be installed at a certain time. For example, the processor 35 may install the software during a downtime, such as when an operational device is not being operated or is available for installation. Alternatively, the processor 35 may install the software during a run-time, such as when the operational device is being operated.

The processor 35 may determine a downtime or installation availability time. The software receiving system downtime may be determined from the operation of the operational device. The downtime may be a time when the operational device is not operating or functioning. For example, the downtime is a time when the imaging device is not imaging. In another example, the installation availability time is a time when the workstation 32 is available to receive and/or install software. This time may be during an uptime or a downtime. For example, an upgrade may be installed when the imaging device is imaging an object but sufficient processing bandwidth is available for installation. In another example, a client may input information relating to a downtime or installation availability time. The processor 35 may determine the downtime or installation availability time from this information. In another example, the processor 35 may determine the downtime or installation availability time from information stored in the memory 36 or from current operation parameters.

The processor 35 may determine when an installation process is complete. The processor 35 may confirm proper installation. For example, the processor 35 may compare the installed software information to the software delivery instructions. The processor 35 may determine whether the correct software was installed in accordance with the instructions, whether the software was installed correctly, whether the installation was complete, whether the software was installed at the correct location, or any other installation information.

The processor 35 may generate a confirmation signal. The confirmation signal may include data that confirms that the software was properly installed. For example, the confirmation signal may confirm that the correct software was installed, the software was installed correctly, the installation was completed, software was installed at the correct location, the time of installation, or any other installation information. The confirmation signal may also include software related information, such as the name of the software installed, the version of software, or other software related information.

The processor 35 may transmit information to the software receiving server 31, software delivery system 20, or any other device in the installation system 10. For example, the processor 35 may transmit the confirmation signal to the software receiving server 31, which may transmit the confirmation signal to the software delivery system via the network 40 or another network. Other confirmation is possible. Email confirmation and user confirmation may be used to confirm installation. In another example, the processor 35 may transmit a scheduled downtime or installation availability time to the software delivery system 20.

The processor 35 may process the software to engage and operate a device, such as a display, communication device, medical device, banking device, any now known or later developed device, or other operational device. The processor 35 may retrieve and operate the software to engage the operational device at a time when the operational device, such as a medical device, is ready to be used.

The memory 36 is computer-readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 36 may be a single device or a combination of devices. The memory 36 may be adjacent to, part of, networked with and/or remote from the processor 35.

The memory 36 may be a computer readable storage media having stored therein data representing instructions executable by the programmed processor 35. The memory 36 stores instructions for the processor 35. The processor 35 is programmed with and executes the instructions. The functions, acts, methods or tasks illustrated in the figures or described herein are performed by the programmed processor 35 executing the instructions stored in the memory 36. The functions, acts, methods or tasks may be independent of the particular type of instructions set, storage media, processor or processing strategy and may be performed by software, hardware, integrated circuits, firm ware, micro-code and the like, operating alone or in combination. The instructions are for implementing the processes, techniques, methods, or acts described herein.

The memory 36 may store information relating to the software receiving system. The information may include, but is not limited to, software, installed software information, instructions, order information, confirmation information, address information, time of delivery information, hardware information, database information, business model data, software order instructions, software order information, medical information, banking information, pharmaceutical information, image data, patient information, or other information relating to a software receiving system, software delivery system, or installation system. The information may be input into the memory 34 from the processor 22, software delivery system 20, or another input device, such as a CD-ROM, keyboard, computer mouse, console, network, remote processor, or remote server.

FIG. 4 shows a method for remote software installation. The method may include determining installation availability for the software receiving system, delivering software to the software receiving system, installing the software on the software receiving system, and delivering a confirmation signal. The method is implemented using the system 10 of FIG. 1 or a different system. Additional, different, or fewer acts than shown in FIG. 4 may be provided. For example, in one embodiment, the method may not include act 430. The acts are performed in the order shown or a different order. The acts may be performed automatically, manually, or combinations thereof.

In act 410, installation availability is determined for the system to receive software. Installation availability relates to a time at which the system is available or able to install software. Determining installation availability may include analyzing a software order schedule, analyzing information related to the system, and generating a software delivery signal. Additional, different, or fewer techniques for determining availability may be provided. For example, analyzing a software order schedule is not necessary. In another example, determining installation availability may include receiving an information signal. Measurements of operation may be used, such as baselining operation of an imaging device or using real-time operation information.

In one embodiment, the data management processor may analyze a software order schedule. The software order schedule may be stored in memory. The schedule may include information relating to the software receiving system. For example, the schedule may include information relating to the installation availability for the software receiving system 30. In another example, the schedule may include a downtime for the software receiving system 30. The processor 21 may analyze the scheduled downtime. In another example, the software receiving system 30 may be available for software installation at any time. This information may be stored in the software order schedule. Using the information stored in the software order schedule, the processor 21 may determine installation availability. Based on the installation availability, the processor 21 determines when software should be delivered to the software receiving system 30. Alternatively, analysis may be completed by the server 22.

Other information may be analyzed to determine installation availability. For example, the data management processor 21 may analyze information transmitted from the software receiving system 30. The software receiving system 30 may transmit a signal that defines installation availability. In another example, the processor 21 may analyze a relational database to determine installation availability. The relational database may be part of or remote from the software order schedule. Alternatively, analysis may be completed by the server 22.

The data management processor may generate a software delivery signal. The software delivery signal may include information relating to software delivery. For example, the software delivery signal may identify the software to be delivered, identify the delivery location, the delivery time, or any other information relating to delivery of the software. The delivery time may relate to the installation availability time. The other information relating to the software delivery system may be stored in the data management memory, for example, as a part of the software order schedule or relational database. Alternatively, generation may be completed by the server.

The data management processor may deliver the software delivery signal to the software delivery server. The software delivery server processor may analyze the software delivery signal. For example, the processor 25 may determine the software to be delivered to the software receiving system 22 from the software delivery signal. The processor 25 may retrieve the software from the software delivery server memory 26. In another example, the processor 25 may identify the delivery location using an address in the software delivery signal. The processor 25 may deliver the software to the delivery location. In another example, the processor 25 may identify a delivery time. The delivery time may be a time at which the software receiving system 30 is available to receive or install software, such as when the receiving system 30 is not being operated. The processor 25 may transmit the software at the delivery time.

In act 420, the software is delivered. Delivering the software may include transmitting the software across a network, The software receiving system may receive the software. The delivery time may be determined by the data management system, server, or software receiving system.

The processor may transmit the software to the software receiving system. For example, the software may be transmitted using a dedicated communication line, wireless device, or other communication device. The software may be delivered using the Internet or a satellite. The software may be secured. The software may be encrypted. The software may be transmitted on a secured line.

The software receiving system may receive the software. The server may receive the software. The server may process the software or transmit the software to the delivery location. For example, the software may be for the server 31. In another example, the software may be for a workstation 32.

In act 430, the software is installed. Installing the software may include installing the software on a server, delivering the software to a client workstation, installing the software on the client workstation, or any combination thereof. Additional, different, or fewer acts may be provided. For example, the software may be stored in the server memory 34 for future delivery to a workstation 32.

The software may be installed on the software receiving server. The software delivery system or the processor may install the software on the server 31. For example, the software delivery system 20 may provide remote installation of the software. In another example, the software receiving system 30 receives the software and the processor 33 installs the software on the software receiving server 31.

The software may be stored in the server memory for future delivery to a workstation. For example, the software may be delivered to the server 31 at a time when the workstation 32 is unable to receive and/or install the software. The processor may store the software in the memory and determine an installation availability time, such as when the workstation is available to receive or install the software. The processor may deliver or install the software at this time.

The receiving server may deliver the software to the workstation. For example, the processor 33 may transmit the software to the workstation 32. The processor may install the software for the workstation or the processor may receive and install the software. The software may be stored on the memory. The software may be used to engage and operate a device, such as a display device, input device, operational device, or any other now known or later developed device. For example, the device may include a medical device. The processor may use the software to engage and operate the medical device. Operation of the medical device may include, for example, treatment or diagnosis of a patient.

Once the software is installed, the workstation or server may generate a confirmation signal. The confirmation signal may confirm the completion of an installation process. Alternatively, the confirmation signal may confirm incomplete or failed installation of the software.

The confirmation signal may be transmitted to the software delivery system. The confirmation signal may be stored in software delivery system. For example, confirmation signal may be recorded in the software order schedule or relational database. The confirmation signal may be used to record successful completion of the software installation.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A remote delivery system for delivering software, the system comprising:
a software receiving system;
a software delivery system operable to automatically deliver software to the receiving system,
wherein the software delivery system is operable to determine a delivery time, the delivery time being a function of timing information stored in the software delivery system, and
wherein the software delivery system is operable to deliver the software at the delivery time.

2. The remote installation system as claimed in claim 1, wherein the software delivery system includes a data management system that stores the timing information.

3. The remote installation system as claimed in claim 2, wherein the data management system triggers the delivery of the software.

4. The remote installation system as claimed in claim 1, wherein the timing information includes software receiving system downtime,

6. The remote installation system as claimed in claim 1, wherein the software receiving system includes a medical device.

7. The remote installation system as claimed in claim 6, wherein the software is operable to engage the medical device.

8. A remote installation system for installing software, the system comprising:
a data management system;
a software receiving system,
wherein the data management system determines a time that the software receiving system is available for installation and installs the software at the determined time.

9. The remote installation system as claimed in claim 8, wherein the time of availability is a software receiving system downtime.

10. The remote installation system as claimed in claim 8, wherein the software receiving system includes a medical device.

11. The remote installation system as claimed in claim 10, wherein the time that the software receiving system is available for installation includes a time that the medical device is not functioning.

12. The remote installation system as claimed in claim 8, wherein the data management system includes a processor and memory.

13. The remote installation system as claimed in claim 12, wherein the processor determines the time of availability from timing information stored in the memory.

14. A remote installation system for installing software for an imaging device, the system comprising:
an imaging device; and
a software delivery system operable to deliver software to the imaging device,
wherein the software delivery system determines when the imaging device is not imaging and delivers the software at this time.

15. The remote installation system as claimed in claim 14, wherein the imaging device is a computer tomography device or a magnetic resonance imaging device.

16. The remote installation system as claimed in claim 14, wherein the imaging device is operable to deliver timing information to the software delivery system, the timing information relating to when the imaging device is not imaging.

17. The remote installation system as claimed in claim 16, wherein the software delivery system delivers software to the imaging device as defined by the timing information.

18. A method for remote installation of software, the method comprising:
determining an available time to deliver software to the software receiving system with a data management system, the available time being a time that the software receiving system is operable to install software; and
delivering the software to the software receiving system at the determined available time with the data management system.

19. The method as claimed in claim 18, wherein the available time includes software receiving system downtime.

20. The method as claimed in claim 18, wherein determining an available time include delivering available time information from the software receiving system to the data management system.

21. The method as claimed in claim 18, wherein delivering the software to the software receiving system includes installing the software on the software receiving system.

22. The method as claimed in claim 21, the method comprising:
generating a confirmation signal with the software receiving system upon installation of the software; and
transmitting the confirmation signal from the software receiving system to the data management system.

23. Computer readable storage media having stored therein data representing instructions executable for delivering software to a software receiving system, the instructions comprising:
identifying a scheduled downtime for the software receiving system, the schedule downtime being stored in and identified by a software delivery system; and
delivering the software at the scheduled downtime.

24. Computer readable storage media as claimed in claim 23, the instructions comprising: installing the software on the software receiving system.

25. Computer readable storage media as claimed in claim 23, the instructions comprising: receiving a confirmation signal from the software receiving system and updating a database relating to the software receiving system with the confirmation signal.
